(19) United States
(12) Patent Application Publication
(10) Pub. No.: US 2004/0099463 A1
(43) Pub. Date: May 27, 2004

(54) Theft protection device for a wheeled trailers

(76) Inventor: Yehuda Baruch, Rishon Le'Zion (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/653,973

(22) Filed: Sep. 4, 2003

(30) Foreign Application Priority Data
Nov. 27, 2002 (IL) 153134

(51) Int. Cl. B60R 25/00

(52) U.S. Cl. 180/287

(57) ABSTRACT

The invention relates to vehicle theft prevention. The invention provides a pneumatic method of preventing the theft of drawn load carriers such as wagons/trailers and semitrailers. Some embodiments of invention comprise a wheeled load carrier of the type fitted with spring-closed pneumatically-opened brakes, the carrier being connectable to a motorized truck section, the carrier having an anti-theft protection device, which when deployed inhibits the unlocking of air-release spring-operated wheel brakes of the carrier, the device including a lockable air valve inserted into a compressed air line connecting a source of compressed air to the brakes, closure of the valve preventing air passage for release of the brakes and opening of the valve allowing passage for compressed air to release the brakes.

### CROSS-REFERENCE TO RELATED APPLICATIONS

This application claims priority from Israel Patent Application No. 153134, filed Nov. 27, 2002.

### FIELD OF AND BACKGROUND OF THE INVENTION

The present invention relates to vehicle theft prevention. More particularly, the invention provides a pneumatic method of preventing the theft of drawn load carriers such as wagons/trailers and semitrailers. The arrangement could also be mounted on lorries.

Car theft is a widely recognized problem, and many known devices are on the market affording car owners a lesser or greater degree of security. Less well known is the fact that also heavy vehicles, even those not provided with a motor, are being stolen. A truck trailer or a semitrailer can be stolen by anyone operating a truck tractor. The financial loss and inconvenience suffered by a business as a result of theft is likely to be at least as severe as the loss of a car. However, most of the devices known against car theft are inapplicable to the protection of heavy wheeled vehicles. Clearly such theft prevention devices as gear locks, steering locks, engine immobilizers, door locks and many others are completely irrelevant for the protection of drawn heavy load carriers.

With regard to a semitrailer, a completely mechanical device is known which encompasses the fifth wheel coupling pin and is secured thereon by a cylinder lock, thus preventing connection of a truck tractor. The device has a number of disadvantages, firstly not being suitable for trailer wagons and secondly being difficult to apply and remove and becoming soiled with grease which is likely to dirty the driver. Many truck drivers prefer taking the risk of theft rather than assembling this device.

An improvement in the field is disclosed by Schulz in U.S. Pat. No. 6,070,688 which describes a mechanical, pneumatically operated mechanism wherein a protruding latching device can be moved and held in proximity to the coupling pin to block access of the fifth wheel. The device involves substantial mechanical changes and is suitable only for semitrailers.

Blehi III proposes a system—also applicable only to semitrailers—which prevents retraction of the landing gear, as seen in U.S. Pat. No. 6,141,997. The system includes adding a retractable non-rotating gear segment to mesh with existing gearing used for retraction of the two support legs or struts. Mechanical modifications of this type are quite expensive when supplied as a retrofit item. Furthermore not all semitrailers have the same type of strut gear mechanism which complicates the supply of a retrofit kit.

### OBJECTS OF THE INVENTION

It is therefore one of the objects of the present invention to obviate the disadvantages of prior art locking devices and to provide a device which is suitable for use to protect both semitrailers and truck trailers.

It is a further object of the present invention to provide a pneumatically-operated locking device which is convenient and easy for use.

A further object of the present invention is to provide a low-cost totally pneumatic system which can be supplied for retrofit at a lower cost than previously known devices.

Yet a further object of the invention is to provide a theft protection device which, if damaged by a person attempting unauthorized removal of the load carrier, will nevertheless prevent theft thereof.

Finally it is an object of the invention to provide a theft protection device which could be automatically activated, if so requested.

### SUMMARY OF THE INVENTION

The present invention achieves the above objects by providing a wheeled load carrier of the type fitted with spring-closed pneumatically-opened brakes, the carrier being connectable to a motorized truck section, said carrier having an anti-theft protection device, which when deployed inhibits the unlocking of air-release spring-operated wheel brakes of said carrier, said device including a lockable air valve inserted into a compressed air line connecting a source of compressed air to said brakes, closure of said valve preventing air passage for release of said brakes and opening of said valve allowing passage for compressed air to release said brakes.

In an exemplary embodiment of the present invention there is provided a carrier wherein said valve is solenoid operated in both directions by an electric pulse and is mounted on said carrier in a hidden location.

In another exemplary embodiment of the present invention the device is automatically activated when the air pressure is released from the system.

In a further exemplary embodiment of the present invention there is provided a conversion kit for retrofitting an anti-theft protection device to a carrier, said kit containing a two-way lockable air valve with valve attachment hardware; tubing for connecting said air valve between an existing air inlet fitting and pneumatically operated brakes of said carrier; tube fitting hardware; and installation instructions. Yet further embodiments of the invention will be described hereinafter.

It will thus be realized that the basic embodiment of the novel device of the present invention serves to prevent theft of valuable vehicles at a cost which is little more than that of a lockable two-way air valve and the corresponding air pressure tubing. The valve is easy to operate by a person having an appropriate key, and can be positioned openly at the side of the vehicle, or enclosed in a lockable steel case attached to the carrier, or disposed in a hidden location. Aside from lock breakage, any type of damage done to the system during a theft attempt will merely cause air leakage and consequently further difficulty in releasing the air-opened spring-closed road wheel brakes. There is no need for any mechanical modification of the load carrier, and the system is applicable to all vehicles, whether semitrailer or truck trailer, being equipped with wheel brakes of the type described.

Various degrees of security can be provided. In some circumstances it will be sufficient that a key is needed to operate the air valve. In other circumstances the valve is solenoid operated in a hidden location, and can be operated only by a special electrical connection and a generated electric pulse provided by the authorized truck tractor. The air valve control could be designed such that the mere disconnecting of air pressure system will activate the device.

It will be noted that the brakes referred to are air opened through a distributor

and pressure booster units. These items will not be described in detail as no novelty is claimed regarding these prior-art components.

### SHORT DESCRIPTION OF THE DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized. In the drawings:

FIG. 1 is a diagrammatic view of an exemplary embodiment of a locking device according to embodiments of the present invention;

FIG. 2 is an elevational view of an embodiment of the present invention as applied to a semitrailer;

FIG. 3 is a schematic diagram of an electro-pneumatic embodiment of the present invention;

FIG. 4 is a schematic view of a retrofit kit in accordance with embodiments of the present invention;

FIG. 5 is a perspective view of a retrofit kit in accordance with embodiments of the present invention;

FIG. 6 is a schematic illustration of a device which is automatically activated in accordance with embodiments of the present invention;

FIG. 7 is a schematic diagram of a further electro-pneumatic embodiment of the present invention shown in a locked position; and

FIG. 8 is a schematic diagram of a further electro-pneumatic embodiment of the present invention shown in an open position.

### FULL DESCRIPTION OF THE INVENTION

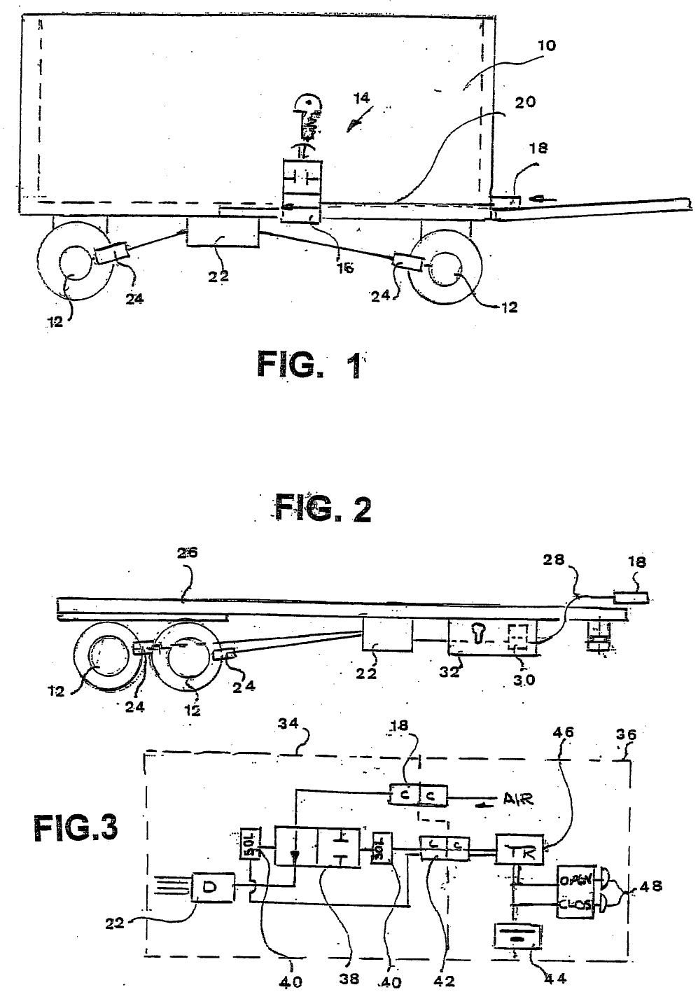

There is seen in FIG. 1 a wheeled load carrier in the form of a truck trailer load carrier 10 provided with spring-closed pneumatically-opened brakes 12. The carrier 10 may be connectable to a motorized truck section (not shown), and may be fitted with an anti-theft protection device 14. When deployed, the anti-theft device 14 prevents unlocking of the wheel brakes 12, as the device 14 includes a lockable 2-way air valve 16 which prevents air pressure from the compressed air inlet coupling 18 reaching the brakes 12.

The lockable valve 16 may be manually operated and may be positioned at the side of the carrier 10 for convenient access.

The valve 16 may be inserted into a compressed air line 20 connecting the coupling 18 to the brakes 12. Closure of the valve 16 prevents air reaching the distributor 22 and the pressure boosters 24, immobilizing the carrier. Opening the valve 16 allows the passage of compressed air to release the brakes 12 so that the carrier can be moved.

With reference to the remaining figures, similar reference numerals may be used to identify similar parts.

Referring now to FIG. 2, there is seen an embodiment where the carrier is a semitrailer 26 and the compressed air line 28 in which the valve is inserted is the MAXI air line. In the present embodiment the air valve 30 may be mounted inside a lockable steel box 32 resistant to forcible opening. Thus a non-lockable air valve 30 may optionally be used.

FIG. 3 schematically shows a wheeled load carrier 34 coupled to a motorized truck section or tractor 36 wherein a two-way valve 38 is solenoid 40 operated in both directions by an appropriate electric pulse. The valve 38 may be advantageously mounted on the carrier 34 in a hidden location. Double solenoid pilots 40 may be fitted for momentary operation. The valve may be operated only through a special electrical connection 42 and a generated electric pulse may be sent from the authorized truck section 36 through this connection 42. For even further security, the solenoids may be arranged to require a pulse of a voltage 110V or 220V substantially higher than the voltage (24V) normally provided by the truck battery 44. For this purpose the truck tractor 36 may be provided with a DC-DC step-up transformer 46. Thus, an attempted theft using electric power normally available on any truck tractor will not open the valve 38. The valve 38 need not be lockable, although if desired the push buttons 48 in the tractor 36 used to release the electrical pulse may be locked.

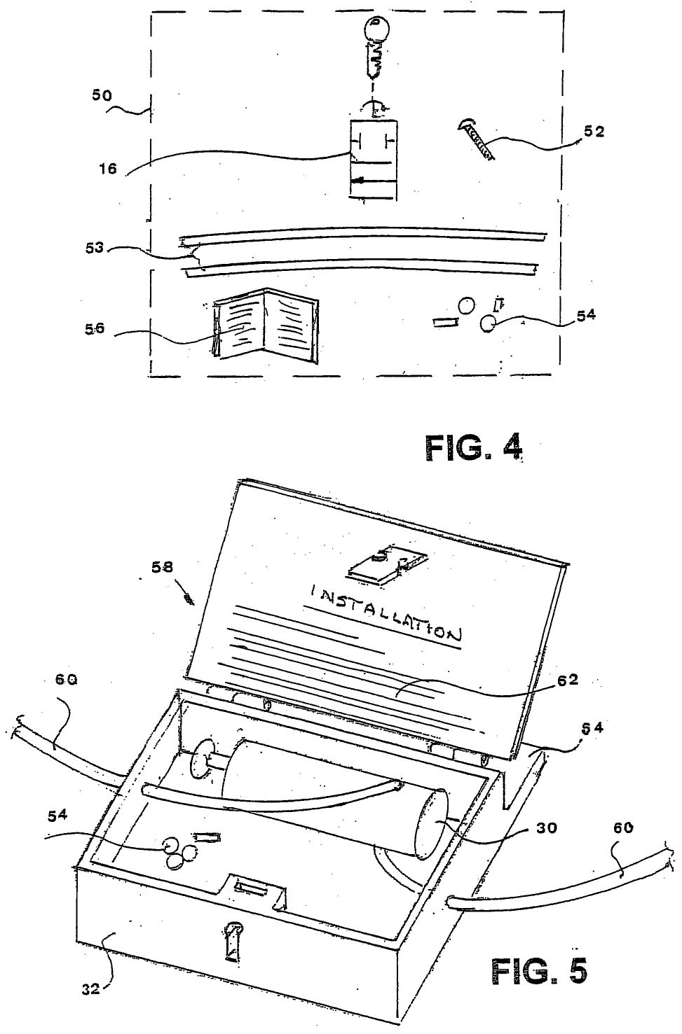

Seen in FIG. 4 is a conversion kit 50 for retrofitting an anti-theft protection device to a carrier of the type illustrated in FIG. 1. The kit 50 may contain the following items: a two-way lockable air valve 16 with keys and valve attachment hardware 52; tubing 53 for connecting the air valve 16 between an existing air inlet coupling and pneumatically operated brakes of the carrier; tube fitting hardware 54 as needed; and installation instructions 56.

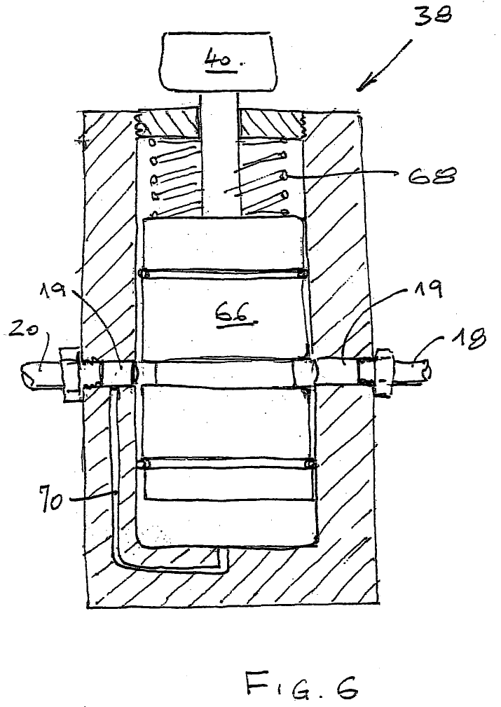

Referring now to FIG. 5, there is depicted a further conversion kit 58 for retrofitting an anti-theft protection device of the type seen in FIG. 2 to a carrier. The kit components listed below may be partially pre-assembled, to enable fast installation. The kit 58 may contain: an openable, lockable steel case 32 attachable to the carrier by means of a flange 64 is provided for this purpose. The flange 64 can be used either for screws or for welding; a two-way air valve 30 contained in the case 32; two tubing lengths 60 extending through the case 32 each ready connected at one end to the air valve 30; tube fitting hardware 54; and installation instructions 62.

FIG. 6 illustrates schematically a valve which may be so designed to be automatically activated. The valve 38 may comprise a cylindrical tubular housing 64 having an inlet port 18 and outlet port 20, an inner core piston 66 urged by spring 68 and to which a solenoid 40 is connected. There may be further provided a by-pass passage 70. The inner core piston is adopted to pivot and axially move urged by spring 68. The valve may be inserted into the compressed air line of the carrier. Activation of solenoid 40 may bring core piston 66 to its “open” position as seen. The air pressure may enter by-pass 70 and hold said core 66 in its position. Alternatively to by-pass 70 an auxiliary valve may be used. Disconnecting the air line may release the pressure, and consequently spring 68 may urge core 66 to a position closing passage 19, preventing air pressure reaching the brakes.

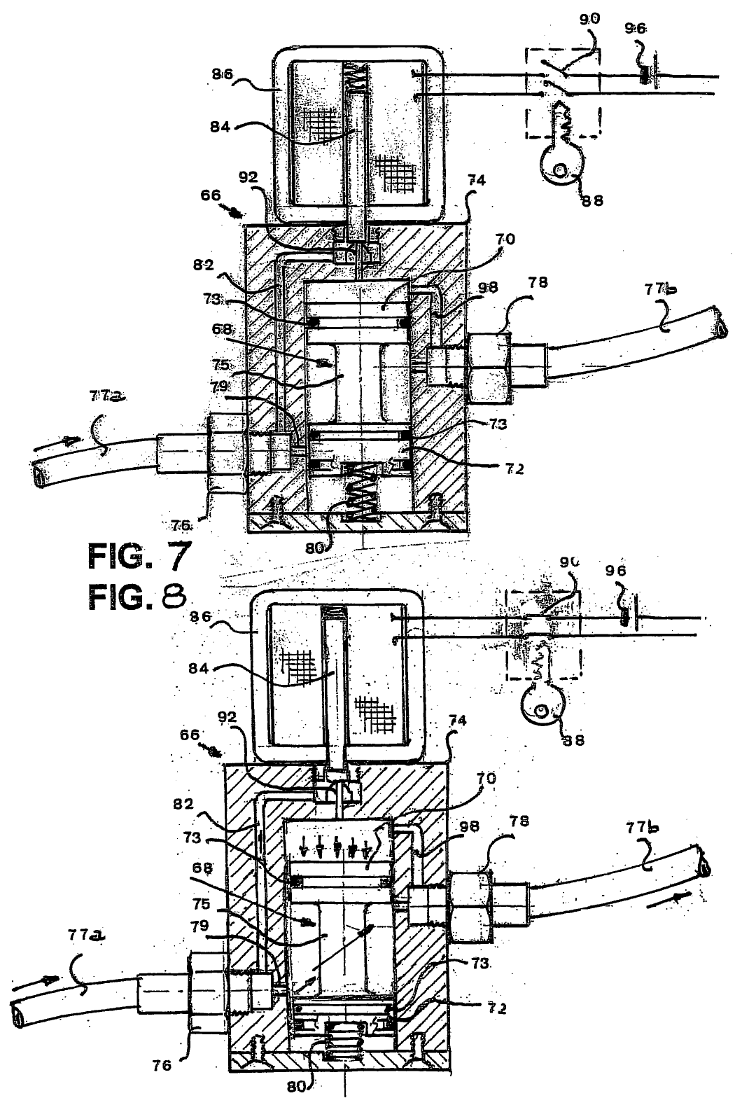

Turning now to FIGS. 7 and 8, and referring again to FIG. 1, there is seen a spring-locked electrically-opened pneumatic theft protection lock 66 for a truck trailer load carrier 10 provided with spring-closed pneumatically-opened brakes 12. The lock 66 may be operatively connected to the vehicle handbrake system and may be connected to the piping upstream of the air distributor 22.

A movable double piston 68 having a first body 70 and a rigidly connected second body 72 may be free to move inside an air cylinder 74. The air piston bodies 70, 72 may be interconnected by a piston rod 75 which may allow air flow (in FIG. 7) between the fittings 76, 78. O rings 73 may be fitted to the double piston 68 as needed to prevent leakage. The air line 77a, 77b for releasing the vehicle brakes 12 may be divided by and fed through the cylinder 74. In the locked state illustrated in FIG. 7, air can not pass from inlet fitting 76 to the outlet fitting 78 because the nozzle 79 is blocked by the second body 72 of the piston 68. The piston 68 may be retained in its blocking position by alight spring 80. Although an additional path 82 may be provided whereby compressed air can enter the cylinder 74, path 82 may be blocked by the spool 84 of a key-operated solenoid 86. Thus the spring 80 may continue to retain the double piston 68 in its blocking position, no air can pass from inlet 76 to outlet 78 and the vehicle brakes 12 remain locked.

An authorized driver in possession of a key 88 may energize the solenoid 86 when wishing to connect to the load carrier 10. Operation of the solenoid 86 by means of switch 90 and electric power source 96 may move the spool 84 away from the nozzle 92 to allow air to flow through the path 82 and apply pressure to the whole top area of the first body 70 of the piston. Such pressure may force the double piston to move against the urging of the spring 80, as seen in FIG. 8. There may now be a clear passage for compressed air to flow from the inlet fitting 76 around the piston rod 75 and to the outlet fitting 78, thus completing the air line and allowing release of the vehicle brakes 12.

When parking the vehicle the brake lock may be reset to the configuration seen in FIG. 7. Release of the solenoid may allow the light solenoid return spring 94 to move the spool 84 back onto the nozzle 92, thus closing air passage 82. As air can drain into passage 98, air pressure above the piston 68 may fall. Consequently, with the help of spring 80, the piston may move in the direction of the solenoid to again block the air inlet nozzle 78. As compressed air becomes unavailable for brake release, the load carrier 10 cannot be removed by anyone unauthorized persons.

The above description of exemplary embodiments of the invention is in now way intended to limit the scope of the invention. The foregoing examples illustrate useful forms of the invention, but are not to be considered as limiting its scope, such as location of the valve and its deployment, and the use on other vehicles, as those skilled in the art will readily be aware that additional variants and modifications of the invention can be formulated without departing from the meaning of the following claims. The scope of the invention is intended to include all embodiments coming within the meaning of the following claims and their equivalents.

What is claimed is:

1. In a wheeled load carrier or lorry provided with spring-closed pneumatically-opened brakes, said carrier being connectable to a motorized truck section, an anti-theft protection apparatus that when deployed inhibits the unlocking of air-release spring-operated wheel brakes of said carrier, said apparatus comprising:
a lockable air valve able to be inserted into a compressed air line connecting a source of compressed air to said brakes, wherein closure of said valve prevents air passage for release of said brakes and wherein opening of said valve allows passage for compressed air to release said brakes.

2. The apparatus of claim 1, wherein said compressed air line is a MAXI air line.

3. The apparatus of claim 1, wherein said air valve is mounted inside a lockable steel box resistant to forcible opening.

4. The apparatus of claim 1, wherein said valve is manually operated and wherein said valve is positioned for convenient access.

5. The apparatus of claim 1, wherein said valve is capable of being electrically operated by an electric motor, and wherein said valve is mounted on said carrier in a hidden location.

6. The apparatus of claim 1 wherein said valve is capable of being electrically operated by a solenoid, and wherein said valve is mounted on said carrier in a hidden location.

7. The apparatus of claim 1, wherein said valve is capable of being automatically activated when the air line is disconnected.

8. The apparatus of claim 1 comprising:
a movable double piston having a first body and a second body free to move inside an air cylinder provided with inlet and outlet ports, wherein said piston bodies are interconnected by a piston rod;
at least one o-ring fitted to the piston to prevent air leakage;
a spring disposed within an underside of said piston; and
a solenoid opposite the underside of said piston.

9. The apparatus of claim 1, wherein said carrier is a semitrailer.

10. A conversion kit for retrofitting an anti-theft protection device to a carrier, said kit comprising:
a two-way lockable air valve with valve attachment hardware;
tubing for connecting said air valve between an existing air inlet fitting and pneumatically operated brakes of said carrier;
tube fitting hardware; and
installation instructions.

11. A conversion kit for retrofitting an anti-theft protection device to a carrier, said kit comprising:
an openable, lockable steel case attachable to said carrier;
a two-way air valve contained in said case;
two tubing lengths extending through said case each ready connected at one end to said air valve;
tube fitting hardware; and
installation instructions.
